(19) United States
(12) Patent Application Publication
(10) Pub. No.: US 2017/0160778 A1
(43) Pub. Date: Jun. 8, 2017

(54) METHOD AND DEVICE FOR MONITORING POWER-CONSUMING APPLICATIONS, USER TERMINAL, COMPUTER PROGRAM AND STORAGE MEDIUM

(71) Applicants: Le Holdings (Beijing) Co., Ltd., Beijing (CN); Lemobile Information Technology (Beijing) Co., Ltd., Beijing (CN)

(72) Inventor: Zihua FENG, Beijing (CN)

(21) Appl. No.: 15/247,628

(22) Filed: Aug. 25, 2016

Related U.S. Application Data
(63) Continuation of application No. PCT/CN2016/088465, filed on Jul. 4, 2016.

(30) Foreign Application Priority Data
Dec. 7, 2015 (CN) 201510891811.X

(51) Int. Cl. G06F 1/28; G06F 11/30; G06F 11/34

(52) U.S. Cl. CPC G06F 1/28; G06F 11/3495; G06F 11/3024

(57) ABSTRACT

The present disclosure provides a method and device for monitoring power-consuming applications, a user terminal, a computer program and a storage medium. The method includes: monitoring a wakelock using state of each application; when the wakelock using state of a certain application satisfies a preset condition, displaying the wakelock using state of the application satisfying the preset condition. According to the method and device for monitoring power-consuming applications and the user terminal provided by the embodiments of the present disclosure, the wakelock using states of various applications are monitored in real time, such that users can accurately know the power consumption conditions of various power-consuming applications; unnecessary power consumption thus can be avoided, and the use experience of users can be enhanced.

### CROSS-REFERENCE TO RELATED APPLICATIONS

This application is a continuation of International Application No. PCT/CN2016/088465, with an international filing date filed on Jul. 4, 2016, which is based upon and claims priority to Chinese Patent Application No. 201510891811.X, filed on Dec. 7, 2015. The disclosure of each of the foregoing application is incorporated herein by reference in its entirety.

### TECHNICAL FIELD

The disclosure relates to the technical field of mobile communications, in particular to a method and device for monitoring power-consuming applications, a user terminal, a computer program and a storage medium.

### BACKGROUND

At present, many android applications are not optimized in the aspect of power consumption. Therefore, more and more applications will hold CPU wakelocks for their own purposes, i.e., preventing interruption of their own tasks by stopping CPUs from sleep.

For example, when a certain application performs some operations that are considered critical by itself, for example, downloading, it will request for a wakelock by means of powerManagerService to prevent the CPU from sleep, and release the wakelock after the completion of the operations. However, some applications usually forget to release for some reasons, or are unwilling to release, thereby leading to that the CPU is in an operating state all the time. Consequently, power is consumed, resulting in increase of power consumption, and the battery life is further shortened. In addition, these tasks all run in background and a user thus cannot be aware of them, and therefore, the power is still consumed fast even though the screen of user's cellphone is turned off. In this case, since users also cannot find out which applications consume power, all problems come down to terminal devices. The use experience of users is reduced.

In the process of implementing the present disclosure, the inventor has found that at least the following problem exists in the prior art:

in the prior art, since those applications consuming excessive power cannot be located accurately, users cannot be aware of the power consumption conditions of various power-consuming applications immediately and make corresponding processing, thereby resulting in increase of system power consumption; therefore, the use experience of users is affected.

### SUMMARY

The purpose of the present disclosure is to provide a method and device for monitoring power-consuming applications, a user terminal, a computer program and a storage medium. Wakelock using states of various applications are monitored in real time, such that users can accurately know the power consumption conditions of various power-consuming applications. As a result, the use experiences of users can be enhanced.

In one aspect, an embodiment of the present disclosure provides a method for monitoring power-consuming applications, including:

monitoring a wakelock using state of each application;

when the wakelock using state of a certain application satisfies a preset condition, displaying the wakelock using state of the application satisfying the preset condition.

In another aspect, an embodiment of the present disclosure provides a device for monitoring power-consuming applications, including:

at least one processor; and

a memory communicably connected with the at least one processor for storing instructions executable by the at least one processor, wherein execution of the instructions by the at least one processor causes the at least one processor to:

monitor a wakelock using state of each application;

display the wakelock using state of the application satisfying the preset condition, when monitoring the wakelock using state of a certain application satisfies a preset condition.

In yet another aspect, an embodiment of the present disclosure further provides a user terminal, including the device for monitoring power-consuming applications as described in the above embodiment.

### BRIEF DESCRIPTION OF THE DRAWINGS

In order to more clearly illustrate the technical solutions in the embodiments of the present disclosure or the prior art, accompanying drawings needing to be used in the descriptions of the embodiments or the prior art will be introduced below briefly. Apparently, the accompanying drawings in the descriptions below are some embodiments of the present disclosure, and for a person of ordinary skill in the art, other drawings may also be obtained according to the accompanying drawings without any creative effort.

FIG. 1 is a flow diagram of a method for monitoring power-consuming applications of an embodiment of the present disclosure.

FIG. 2 is a flow diagram of a method for monitoring power-consuming applications of another embodiment of the present disclosure.

FIG. 3 is a structural schematic diagram of a device for monitoring power-consuming applications of an embodiment of the present disclosure.

FIG. 4 is a structural schematic diagram of a device for monitoring power-consuming applications of another embodiment of the present disclosure.

### DETAILED DESCRIPTION

In order to make the purposes, technical solutions and advantages of the embodiments of the present disclosure more clear, the technical solutions in the embodiments of the present disclosure will be described below clearly and completely in conjunction with the accompanying drawings in the embodiments of the present disclosure. Apparently, the described embodiments are part, but not all, of the embodiments of the present disclosure. All of other embodiments, obtained by a person of ordinary skill in the art based on the embodiments in the present disclosure without any creative effort should fall into the protection scope of the present disclosure.

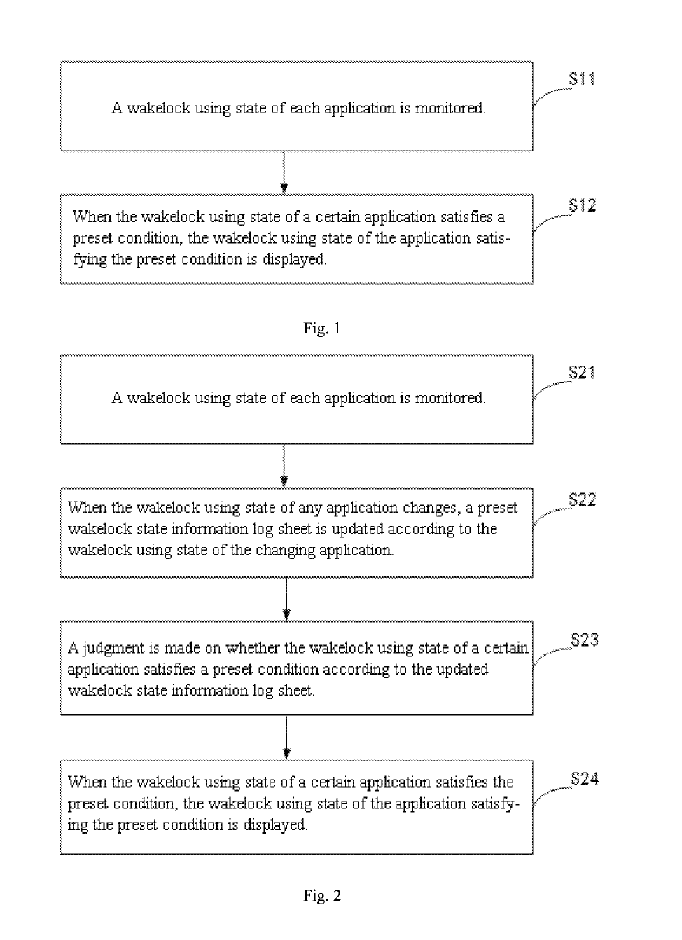

FIG. 1 shows the flow diagram of the method for monitoring power-consuming applications of one embodiment of the present disclosure.

Referring to FIG. 1, the method for monitoring power-consuming applications provided by the embodiment of the present disclosure specifically includes the following steps:

S11, a wakelock using state of each application is monitored.

Specifically, a CPU wakelock monitoring service is added to system services to monitor the wakelock using state of each application in real time.

Wherein, the wakelock using state of each application includes at least holding of a wakelock by the application or not, requesting time, holding time and releasing time of the wakelock, and a wakelock requesting count of the application.

S12, when the wakelock using state of a certain application satisfies a preset condition, the wakelock using state of the application satisfying the preset condition is displayed.

Specifically, by judging whether the wakelock using state of each application satisfies the preset condition, and displaying the wakelock using state of a certain application satisfying the preset condition when the wakelock using state of the application satisfies the preset condition, users are enabled to accurately know the power consumption conditions of various power-consuming applications.

According to the method for monitoring power-consuming applications provided by this embodiment of the present disclosure, the wakelock using states of various applications are monitored in real time, such that users can accurately know the power consumption conditions of various power-consuming applications; besides, the wakelock using states of the applications satisfying a certain condition are displayed to prompt users to carry out processing. Unnecessary power consumption thus can be avoided. As a result, the use experience of users can be enhanced.

In another embodiment of the present disclosure, as shown in FIG. 2, the method for monitoring power-consuming applications provided by the embodiment of the present disclosure specifically includes the following steps:

S21, a wakelock using state of each application is monitored.

S22, when the wakelock using state of a certain application changes, a preset wakelock state information log sheet is updated according to the wakelock using state of the changing application.

S23, a judgment is made on whether the wakelock using state of a certain application satisfies a preset condition according to the updated wakelock state information log sheet.

S24, when the wakelock using state of a certain application satisfies the preset condition, the wakelock using state of the application satisfying the preset condition is displayed.

Specifically, in step S23, it is to judge whether the wakelock using state of each application satisfies the preset condition according to the wakelock state information log sheet updated in step S22, and display the wakelock using state of a certain application satisfying the preset condition when the wakelock using state of the application satisfies the preset condition, such that users can accurately know the power consumption conditions of various power-consuming applications.

In this embodiment of the present disclosure, according to the change of the wakelock using state of each application in a system, the corresponding wakelock using state of the application recorded in the preset wakelock state information log sheet is updated to ensure the accuracy of data recorded in the wakelock state information log sheet, thereby guaranteeing accurate subsequent judgment on whether the wakelock using state of a certain application satisfies the preset condition. In this way, the wakelock using state of the application satisfying the preset condition can be displayed accurately and reliably.

Specifically, step S23 further includes the following steps:

calculating wakelock holding time of each application according to the wakelock state information log sheet, and when the wakelock holding time is not less than a preset time threshold, determining the corresponding application as a first-type problematic application; and/or

calculating a wakelock requesting count of each application according to the wakelock state information log sheet, and when the wakelock requesting count is not less than a preset count threshold, determining the corresponding application as a second-type problematic application.

Accordingly, the operation of displaying the wakelock using state of a certain application satisfying the preset condition when the wakelock using state of the application satisfies the preset condition in step S24 specifically includes:

displaying the wakelock using state(s) of the first-type problematic application and/or the second-type problematic application.

In this embodiment of the present disclosure, the current holding time of each of all held wakelocks and a count of requests for each held wakelock from the corresponding application are calculated periodically at a preset time interval, thereby obtaining statistics of the wakelock holding time of each application and/or the wakelock requesting count of each application.

Wherein, the preset time interval can be set according to a power saving requirement of a user, optionally 1 minute, which is not specifically limited in the present disclosure.

Specifically, if the wakelock holding time exceeds a set time threshold (e.g., 30 minutes), the corresponding application is determined as the first-type problematic application and the wakelock using state of the application is displayed. When a certain wakelock is requested frequently, the corresponding application is determined as the second-type problematic application; the wakelock using state of the application is displayed to leave the choice of turning off the application to a user.

In this embodiment of the present disclosure, the step of displaying the wakelock using state(s) of the first-type problematic application and/or the second-type problematic application specifically includes the following content:

displaying the wakelock using state(s) of the first-type problematic application and/or the second-type problematic application in a preset display interface, and providing a user trigger interface for triggering application processing instructions in the preset display interface.

Specifically, the wakelock using state(s) of the first-type problematic application and/or the second-type problematic application may be displayed for a user by means of a popup dialog box to prompt the user, leaving the choice of turning off the application to the user.

In this embodiment of the present disclosure, a preset region is used as the display interface, and the corresponding wakelock using states of the first-type problematic applications, for each of which the wakelock holding time is greater than the preset time threshold, and/or the second-type problematic applications, for each of which the wakelock requesting count is greater than the preset count threshold (i.e., frequently requesting for the wakelock) are displayed in the display interface; prompts are given to users according to durations of holding and frequency of requesting by each application respectively. Moreover, the user trigger interface for triggering the application processing instructions is provided in the preset display interface.

Wherein, the application processing instructions include at least a forced application release instruction and an application turnoff instruction; the user trigger interface for triggering the application processing instructions may be implemented using such UI components as a dialog box or the like.

According to this embodiment of the present disclosure, recording and control of CPU wakelocks can be well realized, such that users can clearly know which applications are consuming power currently and then carry out processing on corresponding applications.

In this embodiment of the present disclosure, before monitoring the wakelock using state of each application in step S21, the method also includes the following steps:

generating the wakelock state information log sheet for recording the wakelock using state of each application;

wherein, the wakelock state information log sheet includes at least one item of the following information: application unique identifiers, wakelock tags, using states, requesting time, wakelock holding time and requesting counts.

In this embodiment of the present disclosure, the wakelock state information log sheet for recording the wakelock using state of each application is generated in advance before monitoring the wakelock using state of each application. When a certain application requests for the wakelock by means of powerManagerService, a record can be made immediately to the wakelock state information log sheet, including the following specific content: an application unique identifier (UID), a process identifier (PID), a wakelock tag, a using state (holding and releasing), requesting time, a requesting count and the like. Moreover, when the wakelock is released, the released state of the wakelock is marked immediately, and corresponding state changing time is also recorded. During releasing, the released state of the wakelock is marked simultaneously.

In addition, in regard to the above method embodiments, for the sake of simple descriptions, they are expressed as combinations of a series of actions. However, a person skilled in the art should know that the present disclosure is not limited by the described order of actions. Besides, a person skilled in the art should also know that the embodiments described in the description all are optional embodiments, and the actions involved therein are not necessary for the present disclosure.

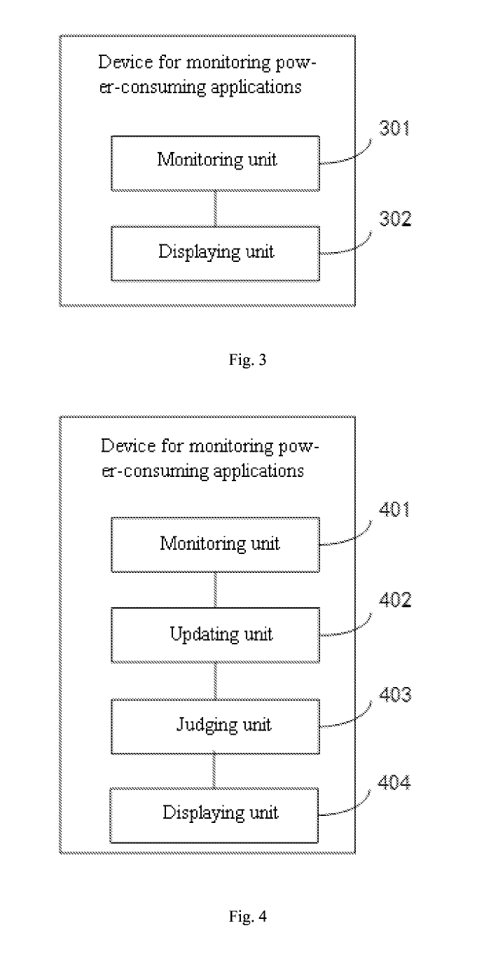

On the basis of the same inventive concept as that of the method, one embodiment of the present disclosure also provides a device for monitoring power-consuming applications. FIG. 3 shows the structural schematic diagram of the device for monitoring power-consuming applications of the embodiment of the present disclosure.

Referring to FIG. 3, the device for monitoring power-consuming applications provided by the embodiment of the present disclosure specifically includes a monitoring unit 301 and a displaying unit 302, wherein

the monitoring unit 301 is used for monitoring a wakelock using state of each application.

Specifically, a CPU wakelock monitoring unit 301 is added to system services to monitor the wakelock using state of each application in real time.

Wherein, the wakelock using state of each application includes at least holding of a wakelock by the application or not, requesting time, holding time and releasing time of the wakelock, and a wakelock requesting count of the application.

The displaying unit 302 is for displaying, when the monitoring unit 301 monitors that the wakelock using state of a certain application satisfies a preset condition, the wakelock using state of the application satisfying the preset condition.

Specifically, displaying unit 302 judges whether the wakelock using state of each application satisfies the preset condition, and displays the wakelock using state of a certain application satisfying the preset condition when the wakelock using state of the application satisfies the preset condition, thereby enabling a user to accurately know the power consumption conditions of various power-consuming applications.

According to the device for monitoring power-consuming applications provided by this embodiment of the present disclosure, the wakelock using states of various applications are monitored in real time, such that users can accurately know the power consumption conditions of various power-consuming applications; besides, the wakelock using states of the applications satisfying a certain condition are displayed to prompt users to carry out processing. Unnecessary power consumption thus can be avoided. As a result, the use experience of users can be enhanced.

In another embodiment of the present disclosure, as shown in FIG. 4, the device for monitoring power-consuming applications provided by the embodiment of the present disclosure specifically includes a monitoring unit 401, an updating unit 402, a judging unit 403, and a displaying unit 404, wherein

the monitoring unit 401 is used for monitoring a wakelock using state of each application;

the updating unit 402 is used for updating, when the wakelock using state of a certain application changes after the monitoring unit monitors the wakelock using state of each application, a preset wakelock state information log sheet according to the wakelock using state of the changing application;

the judging unit 403 is used for judging whether the wakelock using state of a certain application satisfies a preset condition according to the wakelock state information log sheet updated by the updating unit 402;

the displaying unit 404 is used for displaying, when a judgment result of the judging unit 403 indicates that the wakelock using state of a certain application satisfies the preset condition, the wakelock using state of the application satisfying the preset condition.

In this embodiment of the present disclosure, according to the change of the wakelock using state of each application in a system, the corresponding wakelock using state of the application recorded in the preset wakelock state information log sheet is updated to ensure the accuracy of data recorded in the wakelock state information log sheet, thereby guaranteeing accurate subsequent judgment on whether the wakelock using state of a certain application satisfies the preset condition. In this way, the wakelock using state of the application satisfying the preset condition can be displayed accurately and reliably.

Further, the judging unit 403 specifically includes a first calculating subunit and a second calculating subunit, wherein

the first calculating subunit is used for calculating wakelock holding time of each application according to the wakelock state information log sheet, and when the wakelock holding time is not less than a preset time threshold, determining the corresponding application as a first-type problematic application;

a second calculating subunit is used for calculating a wakelock requesting count of each application according to the wakelock state information log sheet, and when the wakelock requesting count is not less than a preset count threshold, determining the corresponding application as a second-type problematic application.

Accordingly, the displaying unit 404 is specifically used for displaying the wakelock using state(s) of the first-type problematic application and/or the second-type problematic application.

In this embodiment of the present disclosure, the current holding time of each of all held wakelocks and a count of requests for each held wakelock from the corresponding application are calculated periodically at a preset time interval, thereby obtaining statistics of the wakelock holding time of each application by the first calculating subunit and/or the wakelock requesting count of each application by the second calculating subunit.

Specifically, the preset time interval can be set according to a power saving requirement of a user, optionally 1 minute, which is not specifically limited in the present disclosure.

Specifically, if the wakelock holding time exceeds a set time threshold (e.g., 30 minutes), the corresponding application is determined as the first-type problematic application and the wakelock using state of the application is displayed by the displaying unit. When a certain wakelock is requested frequently, the corresponding application is determined as the second-type problematic application; the wakelock using state of the application is displayed by the displaying unit to leave the choice of turning off the application to a user.

Further, the displaying unit 404 is specifically used for displaying the wakelock using state(s) of the first-type problematic application and/or the second-type problematic application in a preset display interface, and providing a user trigger interface for triggering application processing instructions in the preset display interface.

Specifically, the displaying unit 404 is capable of displaying the wakelock using state(s) of the first-type problematic application and/or the second-type problematic application for a user by means of a popup dialog box to prompt the user, leaving the choice of turning off the application to the user.

In this embodiment of the present disclosure, a preset region is used as the display interface, and the displaying subunit displays in the display interface the corresponding wakelock using states of the first-type problematic applications, for each of which the wakelock holding time is greater than the preset time threshold, and/or the second-type problematic applications, for each of which the wakelock requesting count is greater than the preset count threshold (i.e., frequently requesting for the wakelock), and gives prompts to users according to durations of holding and frequency of requesting by each application respectively. Moreover, the user trigger interface for triggering the application processing instructions is provided in the preset display interface.

Wherein, the application processing instructions include at least a forced application release instruction and an application turnoff instruction; the user trigger interface for triggering the application processing instructions may be implemented using such UI components as a dialog box or the like.

According to this embodiment of the present disclosure, recording and control of CPU wakelocks can be well realized, such that users can clearly know which applications are consuming power currently and then carry out processing on corresponding applications.

Further, the device also includes a generating unit.

The generating unit is used for generating the wakelock state information log sheet for recording the wakelock using state of each application before the monitoring unit monitors the wakelock using state of each application;

wherein, the wakelock state information log sheet includes at least one item of the following information: application unique identifiers, wakelock tags, using states, requesting time, wakelock holding time and requesting counts.

In this embodiment of the present disclosure, the generating unit generates the wakelock state information log sheet for recording the wakelock using state of each application in advance before the monitoring unit 401 monitors the wakelock using state of each application. When a certain application requests for the wakelock by means of powerManagerService, a record can be made immediately to the wakelock state information log sheet, including the following specific content: an application unique identifier (UID), a process identifier (PID), a wakelock tag, a using state (holding and releasing), requesting time, a requesting count and the like. Moreover, when the wakelock is released, the released state of the wakelock is marked immediately, and corresponding state changing time is also recorded. During releasing, the released state of the wakelock is marked simultaneously.

In regard to the device embodiments, they are just simply described as being substantially similar to the method embodiments, and the correlations therebetween just refer to part of the descriptions of the method embodiments.

Besides, another embodiment of the present disclosure also provides a user terminal that includes the device for monitoring power-consuming applications as described in any above embodiment. Wherein, description is made by taking the device for monitoring power-consuming applications as shown in FIG. 3 as an example. The device includes the monitoring unit 301 and the displaying unit 302, wherein the monitoring unit 301 is used for monitoring the wakelock using state of each application; the displaying unit 302 is for displaying, when the monitoring unit 301 monitors that the wakelock using state of a certain application satisfies the preset condition, the wakelock using state of the application satisfying the preset condition. The user terminal provided by this embodiment of the present disclosure is capable of monitoring the wakelock using states of various applications in real time, such that users can accurately know the power consumption conditions of various power-consuming applications, and displaying the wakelock using states of the applications satisfying a certain condition to prompt users to carry out processing. Unnecessary power consumption thus can be avoided. As a result, the use experience of users can be enhanced.

Yet another embodiment of the present disclosure also discloses a computer program, including program codes for executing the following operations:

monitoring a wakelock using state of each application;

when the wakelock using state of a certain application satisfies a preset condition, displaying the wakelock using state of the application satisfying the preset condition.

Still another embodiment of the present disclosure also discloses a storage medium, used for storing the computer program as described above.

Still another embodiment of the present disclosure also discloses a device that includes:

one or more processors;

a memory;

one or more program modules.

The one or more program modules are stored in the memory, and configured to perform the following operations when executed by the one or more processors:

monitoring a wakelock using state of each application;

when the wakelock using state of a certain application satisfies a preset condition, displaying the wakelock using state of the application satisfying the preset condition.

In conclusion, the method and device for monitoring power-consuming applications, the user terminal, the computer program and the storage medium provided by the embodiments of the present disclosure have the following advantages: the wakelock using states of various applications are monitored in real time, such that users can accurately know the power consumption conditions of various power-consuming applications. Unnecessary power consumption thus can be avoided. As a result, the use experience of users can be enhanced.

The device embodiments described above are merely schematic, wherein the units illustrated as separate assemblies may be physically separated or not; the assemblies displayed as units may be physical units or not, which can be located at the same place or distributed to a plurality of network units. Part or all of the modules may be selected according to actual requirements to achieve the purposes of the solutions of the embodiments. A person of ordinary skill in the art can understand and implement the solutions without any creative effort.

It can be understood by a person of ordinary skill in the art that the implementation of all or part of the steps of the above method embodiments can be completed by means of program instruction related hardware. The aforementioned program can be stored in a computer-readable storage medium. When the program is executed, it executes the steps involved in the above method embodiments. The aforementioned storage medium includes various mediums capable of storing program codes, such as an ROM, an RAM, a magnetic disk, an optical disk or the like.

Finally, it should be noted that the above embodiments are merely intended to illustrate, rather than limit, the technical solutions of the embodiments of the present disclosure. Although the embodiments of the present disclosure are illustrated in detail with reference to the aforementioned embodiments, a person of ordinary skill in the art should understand that modifications may still be made to the technical solutions recorded in the aforementioned embodiments or equivalent substitutions may be made to part or all of the technical features therein; these modifications and substitutions do not cause the nature of the corresponding technical solutions to depart from the scope of the technical solutions in the embodiments of the present disclosure.

What is claimed is:

1. A method for monitoring power-consuming applications, comprising:
monitoring a wakelock using state of each application;
when the wakelock using state of a certain application satisfies a preset condition, displaying the wakelock using state of the application satisfying the preset condition.

2. The method according to claim 1, after monitoring the wakelock using state of each application, further comprising:
when the wakelock using state of a certain application changes, updating a preset wakelock state information log sheet according to the wakelock using state of the changing application;
judging whether the wakelock using state of a certain application satisfies the preset condition according to the updated wakelock state information log sheet.

3. The method according to claim 2, wherein the step of judging whether the wakelock using state of a certain application satisfies the preset condition according to the updated wakelock state information log sheet comprises:
calculating wakelock holding time of each application according to the wakelock state information log sheet, and when the wakelock holding time is not less than a preset time threshold, determining the corresponding application as a first-type problematic application; and/or
calculating a wakelock requesting count of each application according to the wakelock state information log sheet, and when the wakelock requesting count is not less than a preset count threshold, determining the corresponding application as a second-type problematic application;
accordingly, the step of displaying the wakelock using state of a certain application satisfying the preset condition when the wakelock using state of the application satisfies the preset condition comprises:
displaying the wakelock using state(s) of the first-type problematic application and/or the second-type problematic application.

4. The method according to claim 2, before monitoring the wakelock using state of each application, further comprising:
generating the wakelock state information log sheet for recording the wakelock using state of each application,
wherein the wakelock state information log sheet comprises at least one item of the following information: application unique identifiers, wakelock tags, using states, requesting time, wakelock holding time and requesting counts.

5. The method according to claim 3, wherein the step of displaying the wakelock using state(s) of the first-type problematic application and/or the second-type problematic application comprises:
displaying the wakelock using state(s) of the first-type problematic application and/or the second-type problematic application in a preset display interface, and providing a user trigger interface for triggering application processing instructions in the preset display interface.

6. A device for monitoring power-consuming applications, comprising:
at least one processor; and
a memory communicably connected with the at least one processor for storing instructions executable by the at least one processor, wherein execution of the instructions by the at least one processor causes the at least one processor to:
monitor a wakelock using state of each application;
display the wakelock using state of the application satisfying the preset condition, when monitoring the wakelock using state of a certain application satisfies a preset condition.

7. The device according to claim 6, wherein the processor is further configured to:
update a preset wakelock state information log sheet according to the wakelock using state of the changing application, when the wakelock using state of a certain application changes after monitoring the wakelock using state of each application,
judge whether the wakelock using state of a certain application satisfies the preset condition according to the wakelock state information log sheet updated by updating.

8. The device according to claim 7, wherein the processor is further configured to:
calculate wakelock holding time of each application according to the wakelock state information log sheet, and when the wakelock holding time is not less than a preset time threshold, determine the corresponding application as a first-type problematic application; and/or
calculate a wakelock requesting count of each application according to the wakelock state information log sheet, and when the wakelock requesting count is not less than a preset count threshold, determine the corresponding application as a second-type problematic application;
accordingly, display the wakelock using states of the first-type problematic application and/or the second-type problematic application.

9. The device according to claim 7, wherein the processor is further configured to:
generate the wakelock state information log sheet for recording the wakelock using state of each application before monitoring the wakelock using state of each application,
wherein the wakelock state information log sheet comprises at least one item of the following information: application unique identifiers, wakelock tags, using states, requesting time, wakelock holding time and requesting counts.

10. The device according to claim 8, wherein the processor is specifically configured to display the wakelock using states of the first-type problematic application and/or the second-type problematic application in a preset display interface, and provide a user trigger interface for triggering application processing instructions in the preset display interface.

11. A user terminal, comprising the device for monitoring power-consuming applications according to claim 6.
